(19) United States
(12) Patent Application Publication
(10) Pub. No.: US 2024/0015470 A1
(43) Pub. Date: Jan. 11, 2024

(54) SERVER APPARATUS, SYSTEM, AND OPERATING METHOD OF SYSTEM

(71) Applicant: TOYOTA JIDOSHA KABUSHIKI KAISHA, Toyota-shi Aichi-ken (JP)

(72) Inventors: Kai TANAKA, Kumamoto-shi Kumamoto-ken (JP); Junpei OKAMOTO, Sayama-shi Saitama-ken (JP); Makoto KINOSHITA, Edogawa-ku Tokyo-to (JP)

(73) Assignee: TOYOTA JIDOSHA KABUSHIKI KAISHA, Toyota-shi Aichi-ken (JP)

(21) Appl. No.: 18/347,854

(22) Filed: Jul. 6, 2023

(30) Foreign Application Priority Data
Jul. 11, 2022 (JP) 2022-111435

(51) Int. Cl. H04W 4/021; H04W 4/029; G06Q 50/30; G06Q 20/40

(52) U.S. Cl. CPC H04W 4/021; H04W 4/029; G06Q 50/30; G06Q 20/40155

(57) ABSTRACT

A server apparatus includes a communication interface configured to communicate with a terminal apparatus and a controller configured to transmit event information related to an event in an area to the terminal apparatus in response to area information, transmitted by the terminal apparatus, for identifying the area. Upon receiving anticipatory information indicating anticipation of transmission of the area information from the terminal apparatus, the controller is configured to predict an area to be identified by new area information based on past area information and transmit the event information corresponding to the predicted area to the terminal apparatus.

### CROSS-REFERENCE TO RELATED APPLICATION

This application claims priority to Japanese Patent Application No. 2022-111435, filed on Jul. 11, 2022, the entire contents of which are incorporated herein by reference.

### TECHNICAL FIELD

The present disclosure relates to a server apparatus, a system, and an operating method of a system.

### BACKGROUND

Information provision systems for providing various information about the vicinity of a user-specified point are known. For example, Patent Literature (PTL) 1 discloses technology in which event information for the area around a destination set by the user is transmitted from a server to an in-vehicle information terminal, and the in-vehicle information terminal displays the event information.

### CITATION LIST

### Patent Literature

PTL 1: JP H11-88555 A

### SUMMARY

Systems for providing information to users have room for improvement in terms of usability.

It would be helpful to provide a server apparatus and the like that improve usability and contribute to improving the user experience.

A server apparatus in the present disclosure includes:
a communication interface configured to communicate with a terminal apparatus; and
a controller configured to transmit event information related to an event in an area to the terminal apparatus in response to area information, transmitted by the terminal apparatus, for identifying the area, wherein
upon receiving anticipatory information indicating anticipation of transmission of the area information from the terminal apparatus, the controller is configured to predict an area to be identified by new area information based on past area information and transmit the event information corresponding to the predicted area to the terminal apparatus.

A system in the present disclosure includes a terminal apparatus and a server apparatus configured to communicate with each other, wherein
the terminal apparatus is configured to transmit area information for identifying an area to the server apparatus,
the server apparatus is configured to transmit event information related to an event in the area to the terminal apparatus in response to the area information, and
upon receiving anticipatory information indicating anticipation of transmission of the area information from the terminal apparatus, the server apparatus is configured to predict an area to be identified by new area information based on past area information and transmit the event information corresponding to the predicted area to the terminal apparatus.

An operating method of a system in the present disclosure is an operating method of a system including a terminal apparatus and a server apparatus configured to communicate with each other, the operating method including:
transmitting, by the terminal apparatus, area information for identifying an area to the server apparatus;
transmitting, by the server apparatus, event information related to an event in the area to the terminal apparatus in response to the area information; and
predicting, by the server apparatus upon receiving anticipatory information indicating anticipation of transmission of the area information from the terminal apparatus, an area to be identified by new area information based on past area information and transmitting the event information corresponding to the predicted area to the terminal apparatus.

According to the server apparatus and the like in the present disclosure, the user experience can be improved.

### BRIEF DESCRIPTION OF THE DRAWINGS

In the accompanying drawings:

FIG. 1 is a diagram illustrating an example configuration of an information provision system;

FIG. 2 is a sequence diagram illustrating an example of operations of the information provision system;

FIG. 3A is a diagram illustrating an example display by a terminal apparatus;

FIG. 3B is a diagram illustrating an example display by a terminal apparatus;

FIG. 3C is a diagram illustrating an example display by a terminal apparatus;

FIG. 4A is a diagram illustrating an example display by a terminal apparatus;

FIG. 4B is a diagram illustrating an example display by a terminal apparatus;

FIG. 5A is a diagram illustrating an example display by a terminal apparatus; and

FIG. 5B is a diagram illustrating an example display by a terminal apparatus.

### DETAILED DESCRIPTION

Embodiments are described below.

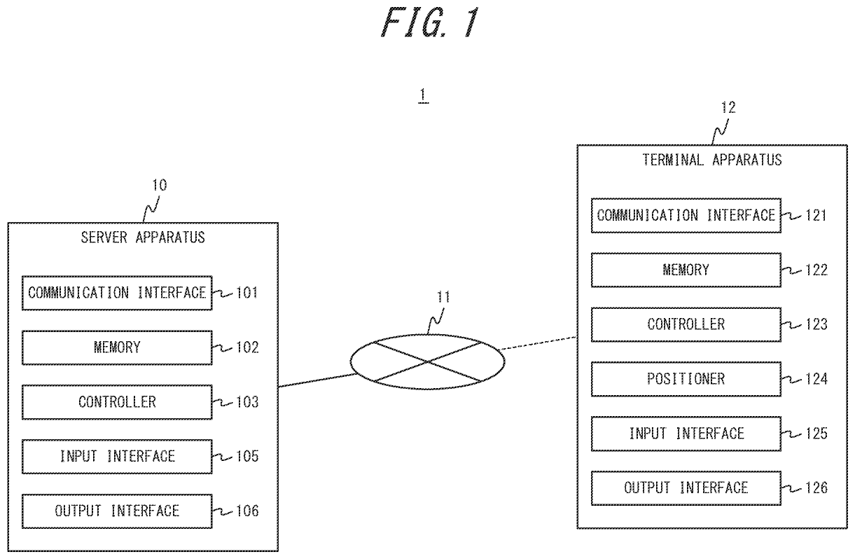

FIG. 1 is a diagram illustrating an example configuration of an information provision system in an embodiment. An information provision system 1 is a system for providing users with information on events appropriate to the area in which the user acts. The information provision system 1 includes one or more each of a server apparatus 10 and a terminal apparatus 12 communicably connected to each other via a network 11.

The server apparatus 10 is, for example, a server computer that belongs to a cloud computing system or other computing system and functions as a server that implements various functions.

The terminal apparatus 13 is an information processing apparatus provided with communication functions, is used by a user, and performs various information communication and information processing. The terminal apparatus 12 is, for example, an information processing terminal such as a smartphone or a tablet terminal.

The network 11 may, for example, be the Internet or may include an ad hoc network, a local area network (LAN), a metropolitan area network (MAN), other networks, or any combination thereof.

In the information provision system 1, the server apparatus 10 transmits event information related to events in an area to the terminal apparatus 12 in response to area information, transmitted by the terminal apparatus 12, for identifying the area. Upon receiving anticipatory information indicating anticipation of transmission of the area information from the terminal apparatus 12, the server apparatus predicts an area to be identified by new area information based on past area information and transmits the event information corresponding to the predicted area to the terminal apparatus 12. Before the user transmits area information for identifying the area to the server apparatus 10 from the terminal apparatus 12, the server apparatus 10 predicts the area and transmits the corresponding event information to the terminal apparatus 12, thereby making it easier for the user to acquire event information. The user experience can thereby be improved.

Next, configurations of the server apparatus 10 and the terminal apparatus 12 are described.

The server apparatus 10 includes a communication interface 101, a memory 102, a controller 103, an input interface 105, and an output interface 106. The server apparatus 10 is, for example, a single computer. The server apparatus 10 may be two or more computers that are communicably connected to each other and operate in cooperation. In this case, the configuration illustrated in FIG. 1 can be arranged among two or more computers as appropriate.

The communication interface 101 includes one or more interfaces for communication. The interface for communication is, for example, a LAN interface. The communication interface 101 receives information to be used for the operations of the server apparatus 10 and transmits information obtained by the operations of the server apparatus 10. The server apparatus 10 is connected to the network 11 by the communication interface 101 and communicates information with the terminal apparatuses 12 via the network 11.

The memory 102 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the controller 103 and information obtained by the operations of the controller 103.

The controller 103 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 103 executes information processing related to operations of the server apparatus 10 while controlling components of the server apparatus 10.

The input interface 105 includes one or more interfaces for input. The interface for input is, for example, a physical key, a capacitive key, a pointing device, a touch screen integrally provided with a display, or a microphone that receives audio input. The input interface 105 accepts operations to input information used for operation of the server apparatus 10 and transmits the inputted information to the controller 103.

The output interface 106 includes one or more interfaces for output. The interface for output is, for example, a display or a speaker. The display is, for example, a Liquid Crystal Display (LCD) or an organic Electro-Luminescent (EL) display. The output interface 106 outputs information obtained by the operations of the server apparatus 10.

The functions of the server apparatus 10 are realized by a processor included in the controller 103 executing a control program. The control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10 and be read from the medium by the server apparatus 10.

The terminal apparatus 12 is, for example, an information processing apparatus such as a smartphone, a tablet terminal, or the like. The terminal apparatus 12 includes a communication interface 121, a memory 122, a controller 123, a positioner 124, an input interface 125, and an output interface 126.

The communication interface 121 includes a communication module compliant with a wired or wireless LAN standard, a module compliant with a mobile communication standard such as Long Term Evolution (LTE), 4th Generation (4G), or 5th Generation (5G), or the like. The terminal apparatus 12 connects to the network 11 via a nearby router apparatus or mobile communication base station using the communication interface 121 and communicates information with the server apparatus 10 and the like over the network 11.

The memory 122 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 122 functions as, for example, a main memory, an auxiliary memory, or a cache memory. The memory 122 stores information to be used for the operations of the controller 123 and information obtained by the operations of the controller 123.

The controller 123 has one or more general purpose processors such as CPUs or micro processing units (MPUs) or one or more dedicated processors that are dedicated to specific processing. Alternatively, the controller 123 may have one or more dedicated circuits such as FPGAs or ASICs. The controller 123 is configured to perform overall control of the operations of the terminal apparatus 12 by operating according to the control/processing programs or operating according to operation procedures implemented in the form of circuits. The controller 123 then transmits and receives various types of information to and from the server apparatus 10 and the like via the communication interface 121 and executes the operations according to the present embodiment.

The positioner 124 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. The positioner 124 acquires positional information for the terminal apparatus 12.

The input interface 125 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 125 accepts operations for inputting information to be used in the operations of the controller 123 and transmits the inputted information to the controller 123.

The output interface 126 includes one or more interfaces for output. The interface for output is, for example, a display or a speaker. The display is, for example, an LCD or an organic EL display. The output interface 126 outputs information obtained by the operations of the controller 123.

The functions of the controller 123 are realized by a processor included in the controller 123 executing a control program. The control program is a program for causing the processor to function as the controller 123. Some or all of the functions of the controller 123 may be realized by a dedicated circuit included in the controller 123.

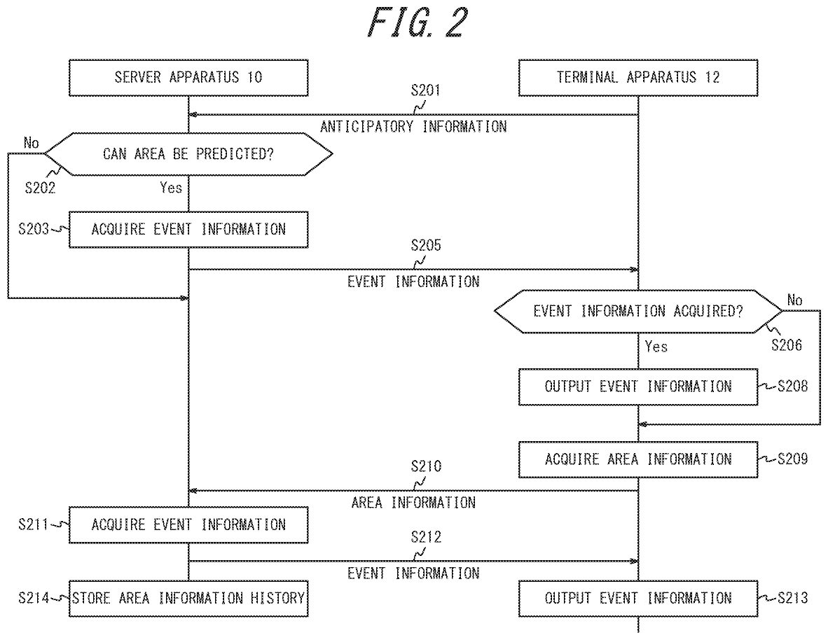

FIG. 2 is a sequence diagram illustrating the operation procedures of the information provision system 1. This sequence diagram illustrates the steps in the coordinated operation of the server apparatus 10 and the terminal apparatus 12. The steps pertaining to the various information processing by the server apparatus 10 and the terminal apparatus 12 in FIG. 2 are performed by the respective controllers 103, 123. The steps pertaining to transmitting and receiving various types of information to and from the server apparatus and the terminal apparatus 12 are performed by the respective controllers 103, 123 transmitting and receiving information to and from each other via the respective communication interfaces 101, 121. In the server apparatus 10 and the terminal apparatuses 12, the respective controllers 103, 123 appropriately store the information that is transmitted and received in the respective memories 102, 122. Furthermore, the controllers 103, 123 accept input of various information by the respective input interfaces 105, 125 and output various information by the respective output interfaces 106, 126. The procedures illustrated in FIG. 2 may be performed in coordination by the server apparatus 10 and each of two or more terminal apparatuses 12.

In step S201, the terminal apparatus 12 transmits anticipatory information to the server apparatus 10. The server apparatus 10 receives the information transmitted from the terminal apparatus 12. The anticipatory information includes information for identifying the terminal apparatus 12 and information indicating the occurrence of a situation that indicates anticipation of transmission of area information to the server apparatus 10 by the terminal apparatus 12. The information for identifying the terminal apparatus is, for example, stored in the memory 102 in advance. The anticipatory information is, for example, any information that is transmitted in response to the terminal apparatus 12 starting up upon being released from sleep mode or powered on. The anticipatory information is, for example, any information that is transmitted in response to the launching of an application program for accepting area information on the terminal apparatus 12 (hereinafter referred to as a “search application”). The terminal apparatus 12 transmits the anticipatory information to the server apparatus 10 at the startup of the terminal apparatus 12 or at the launching of the search application, according to procedures established by the search application when the search application is installed.

Upon receiving the anticipatory information, the server apparatus 10 determines whether the area can be predicted in step S202. The server apparatus 10 determines whether the area to be identified by the new area information, which is likely to be transmitted following the anticipatory information, can be predicted based on past area information. The area is information indicating a point which the user is likely to stay at or pass through (hereafter referred to as the “preferred area”). The area is a range on a map with a freely set area and shape. The server apparatus 10 determines that the area can be predicted in a case in which the amount of the history of past area information associated with the terminal apparatus 12 stored in the memory 102 is at least a reference amount and determines that the area cannot be predicted in a case in which the amount is less than the reference amount. The server apparatus 10 predicts the area to be identified by new area information based on the history of past area information according to any appropriate algorithm or using a model generated by machine learning. The reference amount is any appropriate amount of area information needed for any appropriate algorithm to predict the area. The reference amount is also the amount of information in the training data needed to generate a prediction model through machine learning. The predicted area is the region of a freely set reference range. The reference range is, for example, one to several square kilometers.

If it is determined that the accumulation of past area information history in the server apparatus 10 is insufficient, and the area cannot be predicted (No in step S202), the server apparatus 10 proceeds to step S211. In that case, the server apparatus 10 does not execute the processes of acquiring event information in step S203 and transmitting event information to the terminal apparatus 12 in step S205. Therefore, the terminal apparatus 12 determines that it has not acquired event information in step S206 (No in step S206). For example, upon receiving event information from the server apparatus 10 within a freely set reference time (such as several seconds to several tens of seconds) after transmitting the anticipatory information in step S201, the terminal apparatus 12 determines that the event information was acquired, whereas upon not receiving the event information from the server apparatus 10 within the reference time, the terminal apparatus 12 determines that the event information was not acquired. In a case in which it is determined that the event information has not been acquired (No in step S206), the terminal apparatus 12 proceeds to step S209.

In step S209, the terminal apparatus 12 acquires area information. The area information is acquired by the terminal apparatus 12 in response to user operation of the terminal apparatus 12.

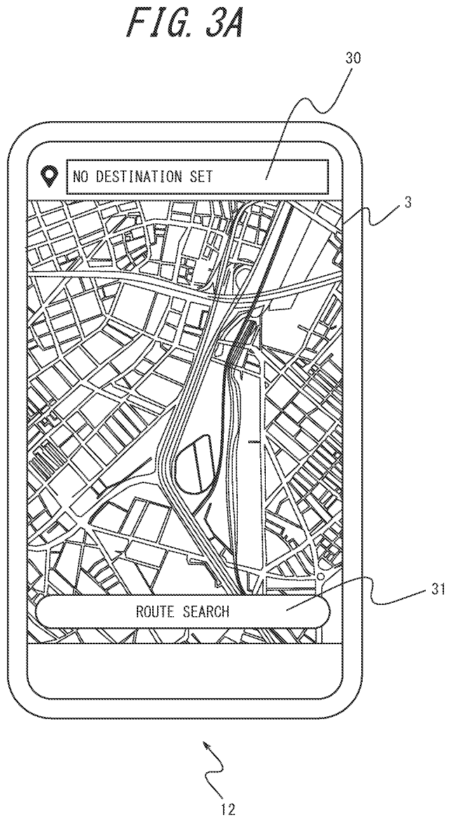

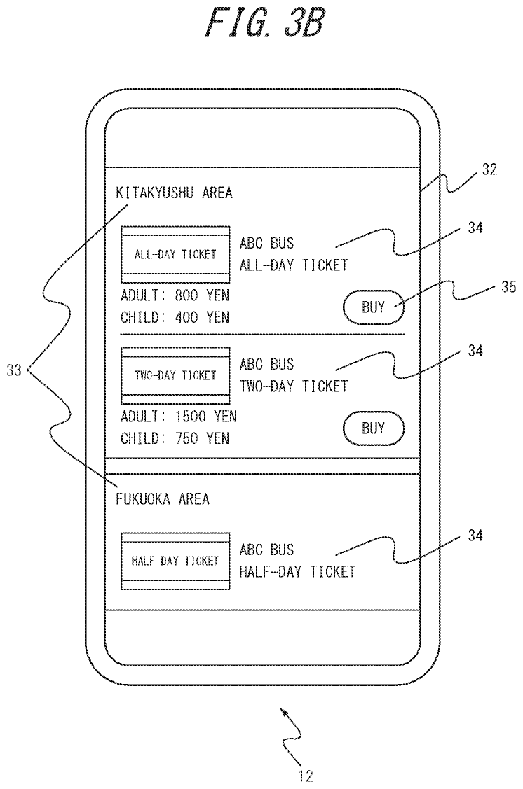

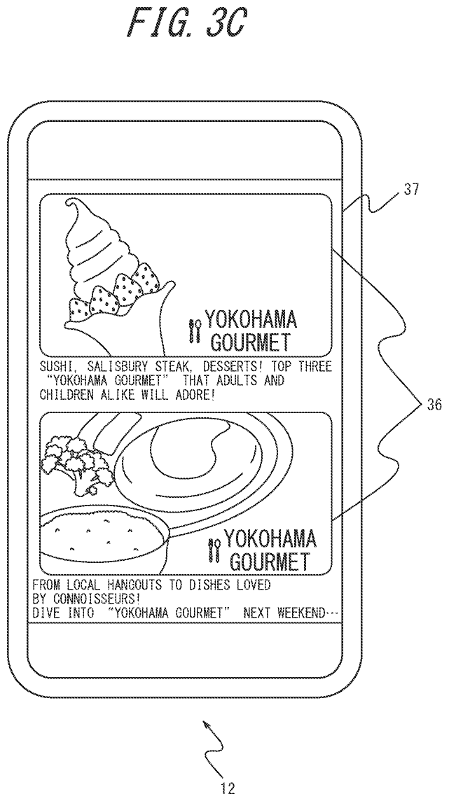

For example, the user uses a search application to input a departure point and destination and instructs the terminal apparatus 12 to search for a route from the departure point to the destination. As illustrated in FIG. 3A, the terminal apparatus 12 displays a search application screen 3 to the user in response to user operation, and when the user enters the destination, departure point, or current location to an input area 30 and taps a route search button 31, a route search is executed and the results are displayed on the screen 3. The terminal apparatus 12 then acquires positional information identifying a preferred area as area information, the preferred area being one or more of the departure point, the destination, and a point on the route.

The user also instructs the terminal apparatus 12 to process the purchase of transportation tickets by online payment or the like, using a function of the search application. The terminal apparatus 12 displays a search application option screen 32 to the user in response to user operation, as illustrated in FIG. 3B. Information such as the name 33 of the area where transportation is available and the type 34 of ticket is displayed on the option screen 32. Transportation includes buses, trains, boats, rented bicycles, and the like, but an example of a bus is illustrated here. When the user taps a buy button 35 to purchase a ticket for the desired area, a process to pay the transportation fare for the ticket purchase is initiated. Then, the terminal apparatus 12 acquires positional information identifying a preferred area as area information, the preferred area being one or more of the areas passed through by the transportation that is rideable using the purchased ticket.

Alternatively, the terminal apparatus 12 maintains a history of its own positional information and acquires positional information identifying a preferred area as the area information, the preferred area being points at which the time spent exceeds any appropriate reference time (such as several hours). In this case, the preferred area is home, work, school, or the like.

In step S210, the terminal apparatus 12 transmits the area information to the server apparatus 10. The server apparatus 10 receives the information transmitted from the terminal apparatus 12.

In step S211, the server apparatus 10 acquires event information. The server apparatus 10 acquires event information for events held in the area identified by the area information. An event may, for example, be currently underway or may be scheduled to take place at a predetermined period of time in the future. A predetermined period of time in the future could, for example, be days to weeks. The server apparatus 10 collects event information from sources such as servers operated by various event providers. The event information includes information on where and when the event will be held. The server apparatus 10 acquires the event information by extracting the event information for events to be held on or after the current date and time in the identified area.

In step S212, the server apparatus 10 transmits the event information to the terminal apparatus 12. The terminal apparatus 12 receives the information transmitted from the server apparatus 10.

In step S213, the terminal apparatus 12 outputs the event information. The terminal apparatus 12 transitions from the search application screen 3 and the option screen 32 to the event information screen 37 and displays event information 36, as illustrated in FIG. 3C, for example. The event information 36 includes a character string and image indicating the content of the event. Upon a portion where the event information 36 is displayed being tapped, the terminal apparatus 12 can transition to another screen to display information such as a more detailed location, date, and time pertaining to the tapped event information 36.

On the other hand, in step S214, the server apparatus 10 stores a history of the area information in the memory 102. The history of the area information is stored in association with identification information for the terminal apparatus 12 or identification information for the user identified thereby. This enables the server apparatus 10 to accumulate a history of area information indicating the preferred area in association with the terminal apparatus 12 or the corresponding user. The history of event information provision may be stored in association with the area information.

When receiving the anticipatory information from the terminal apparatus 12 in step S201, the server apparatus 10 proceeds to step S203 if the history of the area information has been accumulated to a certain degree and it was determined in step S202 that the area can be predicted (Yes).

In step S203, the server apparatus 10 acquires event information. The server apparatus 10 predicts the area to be identified by the area information that will be transmitted by the terminal apparatus 12. The server apparatus 10 predicts the area to be identified by new area information based on the history of past area information according to any appropriate algorithm or using a model generated by machine learning. The server apparatus 10 then acquires the event information for events to be held in the predicted area. The server apparatus 10 acquires the event information by the same operations as in step S211.

In step S205, the server apparatus 10 transmits the event information to the terminal apparatus 12. The terminal apparatus 12 receives the information transmitted from the server apparatus 10. The terminal apparatus 12 then determines that the event information has been acquired in step S201 (Yes) and proceeds to step S208.

In step S208, the terminal apparatus 12 outputs the event information.

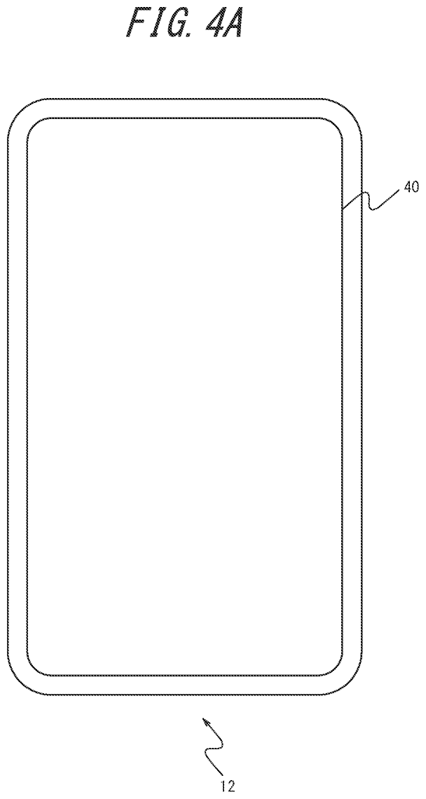

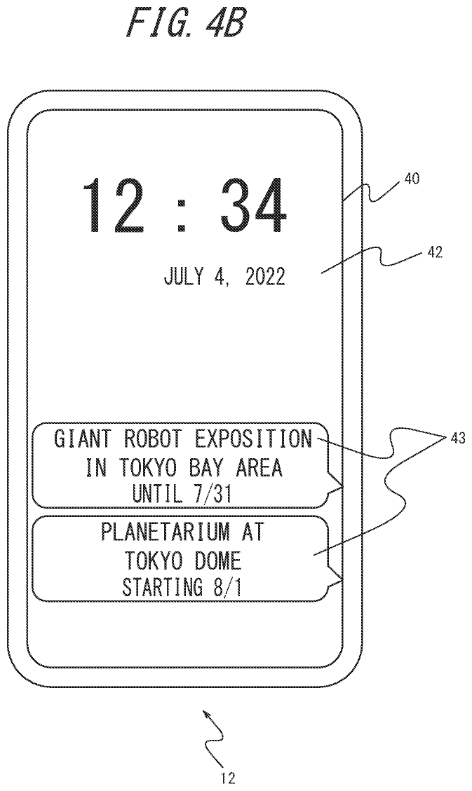

FIGS. 4A and 4B illustrate examples of event information. FIG. 4A illustrates an example of the terminal apparatus 12, and its display screen 40, in a power-off or sleep state. Upon being powered on or released from sleep mode, the terminal apparatus 12 transmits anticipatory information to the server apparatus 10 in response to these operations and receives event information from the server apparatus 10. As illustrated in FIG. 4B, the terminal apparatus 12 displays a standby screen 42 on the display screen 40 and also displays event information 43 on the standby screen 42. The event information 43 is a character string containing information on the location where the event will be held and the next period in which the event will be held. The event information 43 may be outputted by audio.

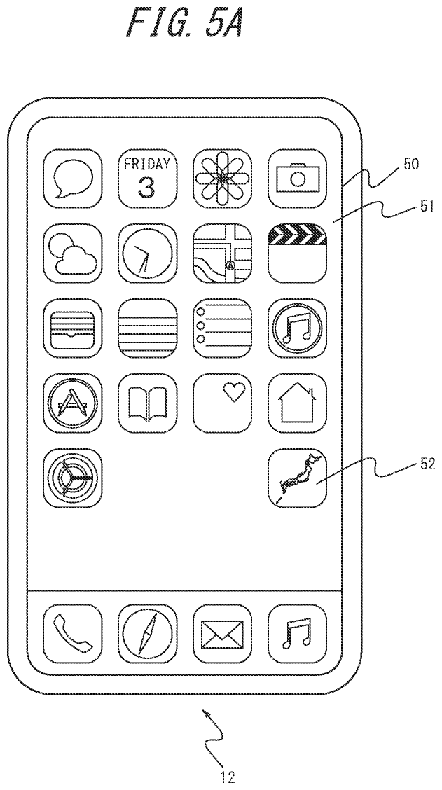

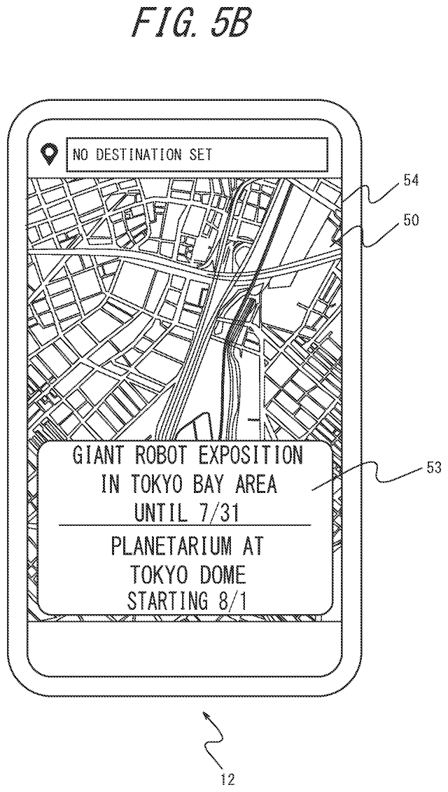

FIGS. 5A and 5B illustrate another example of event information. FIG. 5A illustrates an example of the terminal apparatus 12, and its display screen 50, in a standby state. A standby screen 51 is displayed on the display screen 50. For example, when an operation such as a tap is performed on a search application icon 52 on the standby screen 51, the terminal apparatus 12 transmits anticipatory information to the server apparatus 10 in response to the operation and receives event information from the server apparatus 10. As illustrated in FIG. 5B, the terminal apparatus 12 displays a search application screen 54 on the display screen 50 and also displays event information 53 overlaid on the search application screen 54.

In this way, the server apparatus 10 provides event information to the terminal apparatus 12 in response to anticipatory information from the terminal apparatus 12, so that the user of the terminal apparatus 12 can recognize event information without having to input information to identify a preferred area. Accordingly, the convenience for the user improves.

After reviewing the event information, the user uses the search application to cause the terminal apparatus 12 to execute the desired operation. For example, operations from step S208 onward are performed. The steps from step S211 onward are then executed on the server apparatus 10 in response.

According to the present embodiment, before the user transmits area information for identifying the preferred area to the server apparatus 10 from the terminal apparatus 12, the server apparatus 10 predicts the preferred area and transmits the corresponding event information to the terminal apparatus 12, thereby making it easier for the user to acquire event information. User convenience is thus improved, and the user experience can be enhanced.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each element, each step, or the like can be rearranged without logical inconsistency, and a plurality of elements, steps, or the like can be combined into one or divided.

1. A server apparatus comprising:
a communication interface configured to communicate with a terminal apparatus; and
a controller configured to transmit event information related to an event in an area to the terminal apparatus in response to area information, transmitted by the terminal apparatus, for identifying the area, wherein
upon receiving anticipatory information indicating anticipation of transmission of the area information from the terminal apparatus, the controller is configured to predict an area to be identified by new area information based on past area information and transmit the event information corresponding to the predicted area to the terminal apparatus.

2. The server apparatus according to claim 1, wherein the anticipatory information is information transmitted by the terminal apparatus in response to startup of the terminal apparatus or launching of a predetermined application program by the terminal apparatus.

3. The server apparatus according to claim 1, wherein the area information is acquired from information received from the terminal apparatus to search for a point or a route.

4. The server apparatus according to claim 1, wherein the area information is acquired from information received from the terminal apparatus for paying a transportation fare.

5. The server apparatus according to claim 1, wherein the area information is acquired from a history, received from the terminal apparatus, of positional information for the terminal apparatus.

6. The server apparatus according to claim 1, wherein the event information includes information on a location or timing of an event to be held in an area corresponding to the area information.

7. The server apparatus according to claim 1, wherein the controller is configured to determine whether the area to be identified by the new area information can be predicted according to accumulation of the past area information.

8. A system comprising a terminal apparatus and a server apparatus configured to communicate with each other, wherein
the terminal apparatus is configured to transmit area information for identifying an area to the server apparatus,
the server apparatus is configured to transmit event information related to an event in the area to the terminal apparatus in response to the area information, and
upon receiving anticipatory information indicating anticipation of transmission of the area information from the terminal apparatus, the server apparatus is configured to predict an area to be identified by new area information based on past area information and transmit the event information corresponding to the predicted area to the terminal apparatus.

9. The system according to claim 8, wherein the anticipatory information is information transmitted by the terminal apparatus in response to startup of the terminal apparatus or launching of a predetermined application program by the terminal apparatus.

10. The system according to claim 8, wherein the area information is acquired from information received from the terminal apparatus to search for a point or a route.

11. The system according to claim 8, wherein the area information is acquired from information received from the terminal apparatus for paying a transportation fare.

12. The system according to claim 8, wherein the area information is acquired from a history, received from the terminal apparatus, of positional information for the terminal apparatus.

13. The system according to claim 8, wherein the event information includes information on a location or timing of an event to be held in an area corresponding to the area information.

14. The system according to claim 8, wherein the server apparatus is configured to determine whether the area to be identified by the new area information can be predicted according to accumulation of the past area information.

15. An operating method of a system comprising a terminal apparatus and a server apparatus configured to communicate with each other, the operating method comprising:
transmitting, by the terminal apparatus, area information for identifying an area to the server apparatus;
transmitting, by the server apparatus, event information related to an event in the area to the terminal apparatus in response to the area information; and
predicting, by the server apparatus upon receiving anticipatory information indicating anticipation of transmission of the area information from the terminal apparatus, an area to be identified by new area information based on past area information and transmitting the event information corresponding to the predicted area to the terminal apparatus.

16. The operating method of a system according to claim 15, wherein the anticipatory information is information transmitted by the terminal apparatus in response to startup of the terminal apparatus or launching of a predetermined application program by the terminal apparatus.

17. The operating method of a system according to claim 15, wherein the area information is acquired from information received from the terminal apparatus to search for a point or a route.

18. The operating method of a system according to claim 15, wherein the area information is acquired from information received from the terminal apparatus for paying a transportation fare.

19. The operating method of a system according to claim 15, wherein the area information is acquired from a history, received from the terminal apparatus, of positional information for the terminal apparatus.

20. The operating method of a system according to claim 15, wherein the event information includes information on a location or timing of an event to be held in an area corresponding to the area information.
